(19) United States
(12) Patent Application Publication
(10) Pub. No.: US 2026/0332313 A1
(43) Pub. Date: Oct. 22, 2026

(54) TIMER HANDLING FOR DATA TRANSMISSION

(71) Applicant: Apple Inc., Cupertino, CA (US)

(72) Inventors: Ping-Heng Kuo, London (GB); Fangli Xu, Beijing (CN); Ralf Rossbach, Munich (DE)

(21) Appl. No.: 19/113,127

(22) PCT Filed: Sep. 30, 2022
(86) PCT No.: PCT/CN2022/123263

§ 371 Date: Mar. 19, 2025

(51) Int. Cl. H04L 1/1829; H04L 1/1812

(52) U.S. Cl. CPC H04L 1/1848; H04L 1/1812

(57) ABSTRACT

Methods, systems, apparatuses, and computer programs for uplink grant timer handling for a PUSCH transmission cluster is disclosed. In one aspect, the method can include actions of processing an uplink grant corresponding to a plurality of PUSCH transmissions, transmitting at least two of the plurality of PUSCH transmissions, and starting a single timer relating to at least two HARQ processes of a plurality of HARQ processes, wherein each HARQ process of the plurality of HARQ processes is associated with a PUSCH transmission of the plurality of PUSCH transmissions.

### BACKGROUND

Wireless communication networks provide integrated communication platforms and telecommunication services to wireless user devices. Example telecommunication services include telephony, data (e.g., voice, audio, and/or video data), messaging, internet-access, and/or other services. The wireless communication networks have wireless access nodes that exchange wireless signals with the wireless user devices using wireless network protocols, such as protocols described in various telecommunication standards promulgated by the Third Generation Partnership Project (3GPP). Example wireless communication networks include code division multiple access (CDMA) networks, time division multiple access (TDMA) networks, frequency-division multiple access (FDMA) networks, orthogonal frequency-division multiple access (OFDMA) networks, Long Term Evolution (LTE), and Fifth Generation New Radio (5G NR). The wireless communication networks facilitate mobile broadband service using technologies such as OFDM, multiple input multiple output (MIMO), advanced channel coding, massive MIMO, beamforming, and/or other features.

### SUMMARY

According to one innovative aspect of the present disclosure, a method, to be performed by a user equipment (UE), for configured grant timer handling for PUSCH transmission cluster is disclosed. In one aspect, the method can include processing an uplink grant corresponding to a plurality of physical uplink shared channel (PUSCH) transmissions, transmitting at least two of the plurality of PUSCH transmissions, and starting a single timer relating to at least two hybrid automatic repeat request (HARQ) processes of a plurality of HARQ processes, wherein each HARQ process of the plurality of HARQ processes is associated with a PUSCH transmission of the plurality of PUSCH transmissions.

Other aspects includes apparatuses, systems, and computer programs for performing the actions of the aforementioned method.

The innovative method can include other optional features. For example, in some implementations, the single timer is a configured grant timer or a configured grant retransmission timer related to the plurality of HARQ processes.

In some implementations, the uplink grant is a configured grant or a dynamic grant.

In some implementations, each of the plurality of PUSCH transmissions is associated to a different start time.

In some implementations, the single timer starts at a time corresponding to: a beginning of a first PUSCH transmission of the plurality of PUSCH transmissions, a beginning of a second PUSCH transmission of the plurality of PUSCH transmissions, a termination of the first PUSCH transmission of the plurality of PUSCH transmissions, or a termination of the second PUSCH transmission of the plurality of PUSCH transmissions.

In some implementations, the method can further include refraining from performing a new transmission on one or more configured grant resources associated with one or more of the plurality of HARQ processes while the single timer is running.

In some implementations, the UE is preconfigured with a duration of the single timer.

In some implementations, the UE is configured with a duration of the single timer via radio resource control (RRC) signaling.

In some implementations, the method can further include determining, by the UE, a duration of the CG timer based on one or more conditions.

In some implementations, the one or more conditions including (i) a number of PUSCH transmissions in the PUSCH transmission cluster, (ii) spacing of PUSCH transmission within the PUSCH transmission cluster, or (iii) when a last PUSCH transmission in the PUSCH transmission cluster ends.

In some implementations, the uplink grant is received via physical downlink control channel (PDCCH) includes an indication of a start time of the single timer.

According to another innovative aspect of the present disclosure, a method, to be performed by a UE, for configured grant timer handling for PUSCH transmission cluster is disclosed. In one aspect, the method can include actions of processing an uplink grant corresponding to a plurality of physical uplink shared channel (PUSCH) transmissions, wherein the plurality of PUSCH transmissions is associated with a plurality of hybrid automatic repeat request (HARQ) processes, transmitting at least a set of the plurality of PUSCH transmissions, starting a set of timers that (i) relate to a set of the plurality of HARQ processes and (ii) are configured to run until a common expiration point, and considering the set of timers as running until the set of timers reaches the common expiration point.

Other aspects includes apparatuses, systems, and computer programs for performing the actions of the aforementioned method.

The innovative method can include other optional features. For example, in some implementations, the method can further include stopping the set of timers at the common expiration point.

In some implementations, the method can further include refraining from performing a new transmission on one or more uplink grant resources associated with one or more of the plurality of HARQ processes when the respective timer for the one or more uplink grant resources is running.

In some implementations, the set of timers are configured grant timers and each of the configured grant timers are associated with a different HARQ process.

In some implementations, the set of timers are configured grant retransmission timers and each of the configured grant retransmission timers are associated with a different HARQ process.

In some implementations, the uplink grant is a configured grant or a dynamic grant.

In some implementations, each of the plurality of PUSCH transmissions is associated to a different start time.

In some implementations, each of the set of timers starts at a beginning of each of the plurality of PUSCH transmissions.

In some implementations, a set of PDU are to be transmitted using the plurality of PUSCH transmissions, the common expiration point is based on a PDU set delay budget (PSDB) of the set of PDU to be transmitted using the PUSCH transmission cluster.

In some implementations, the processed uplink grant is received in physical downlink control channel (PDCCH), and a value for the common expiration point is also received in the PDCCH.

In some implementations, the UE is preconfigured with a common expiration point related to when the set of timers is to expire.

In some implementations, the common expiration point is a predetermined amount of time after a first PUSCH transmission or after a last PUSCH transmission of the PUSCH transmission cluster.

In some implementations, the predetermined amount of time is a predetermined number of milliseconds, a predetermined number of orthogonal frequency division multiplexing (OFDM) symbols, or a predetermined number of slots.

In some implementations, the method can further include dynamically determining the common expiration point related to when each of the set of timers is to expire.

In some implementations, the method can further include determining the common expiration point related to when each of the CG timers is to expire based on an offset associated with one or more PUSCH transmissions of the plurality of PUSCH transmissions.

In some implementations, determining the common expiration point related to when each of the CG timers is to expire based on an offset associated with one or more PUSCH transmissions of the plurality of PUSCH transmissions can further include adjusting, for each particular PUSCH transmission of the plurality of PUSCH transmissions, a preconfigured timer for HARQ processes in the particular PUSCH based on the offset associated with the particular PUSCH transmission.

### BRIEF DESCRIPTION OF THE DRAWINGS

FIG. 1 illustrates a wireless network, according to some implementations.

FIG. 2 illustrates a visualization of an uplink grant timer.

FIG. 3 illustrates a visualization of a PUSCH cluster used for transmission of a PDU set.

FIG. 4 illustrates a visualization of a PUSCH cluster applied in a uplink grant.

FIG. 5A illustrates a visualization of an example of a problem that arises when using conventional uplink grant timers with a PUSCH cluster.

FIG. 5B illustrates a visualization of an example of another problem that arises when using conventional uplink grant timers with a PUSCH cluster.

FIG. 6 illustrates a visualization of an example of a single uplink grant timer relating to a plurality of HARQ processes associated with a PUSCH cluster, in accordance with one aspect of the present disclosure.

FIG. 7 illustrates another visualization of an example of a single uplink grant timer relating to a plurality of HARQ processes associated with a PUSCH cluster, in accordance with one aspect of the present disclosure.

FIG. 8 is a flowchart of a process for implementing a single uplink grant timer related to a plurality of HARQ processes associated with a PUSCH cluster, in accordance with one aspect of the present disclosure.

FIG. 9 illustrates a visualization of an example of use of a common expiration time for a plurality of uplink grant timers that each relate to a respective HARQ process associated with a PUSCH cluster, in accordance with one aspect of the present disclosure.

FIG. 10 is a flowchart of an example of a process for implementing a common expiration timer a plurality of uplink grant timers that each relate to a respective HARQ process associated with a PUSCH cluster, in accordance with one aspect of the present disclosure.

FIG. 11 illustrates a user equipment (UE), according to some implementations.

FIG. 12 illustrates an access node, according to some implementations.

### DETAILED DESCRIPTION

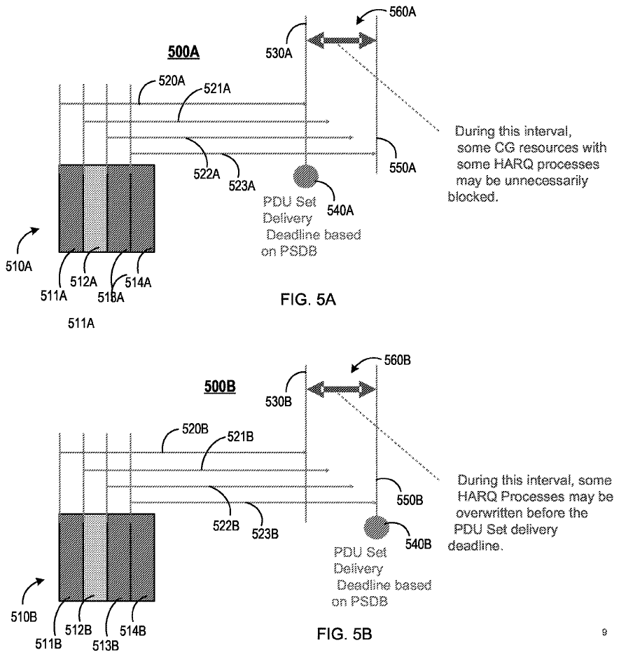

The present disclosure is directed towards systems, devices, methods, and computer programs for uplink grant timer handling for a physical uplink shared channel (PUSCH) transmission cluster. In particular, the present disclosure provides for a single uplink grant timer for a PUSCH transmission cluster or, in the alternative, a common expiry point for a set of multiple uplink grant timers for a PUSCH transmission cluster that improve use of configured grant (CG) resources. In particular, the implementations of a single uplink grant timer for a PUSCH transmission cluster or, in the alternative, a common expiry for a set of multiple uplink grant timers associated with a PUSCH transmission cluster can, among other things, eliminate an interval of time that exists in conventional methods as a result of staggered termination of uplink grant timers (see e.g., FIGS. 5A and 5B). Technological benefits of the elimination of this timer interval are discussed in more detail herein.

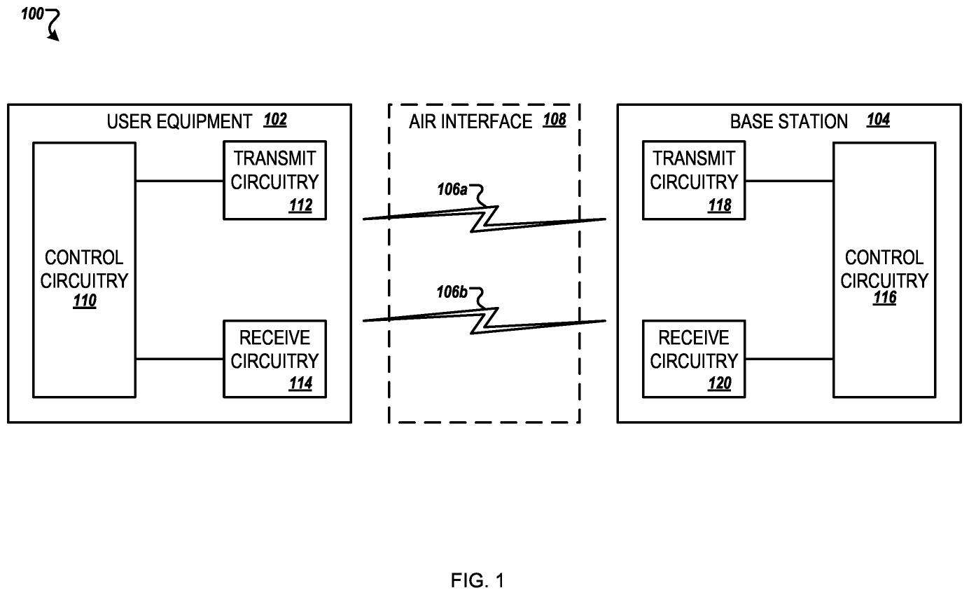

FIG. 1 illustrates a wireless network 100, according to some implementations. The wireless network 100 includes a UE 102 and a base station 104 connected via one or more channels 106A, 106B across an air interface 108. The UE 102 and base station 104 communicate using a system that supports controls for managing the access of the UE 102 to a network via the base station 104.

In some implementations, the wireless network 100 may be a Non-Standalone (NSA) network that incorporates Long Term Evolution (LTE) and Fifth Generation (5G) New Radio (NR) communication standards as defined by the Third Generation Partnership Project (3GPP) technical specifications. For example, the wireless network 100 may be a E-UTRA (Evolved Universal Terrestrial Radio Access)-NR Dual Connectivity (EN-DC) network, or a NR-EUTRA Dual Connectivity (NE-DC) network. However, the wireless network 100 may also be a Standalone (SA) network that incorporates only 5G NR. Furthermore, other types of communication standards are possible, including future 3GPP systems (e.g., Sixth Generation (6G)) systems, Institute of Electrical and Electronics Engineers (IEEE) 802.11 technology (e.g., IEEE 802.11a; IEEE 802.11b; IEEE 802.11g; IEEE 802.11-2007; IEEE 802.11n; IEEE 802.11-2012; IEEE 802.11ac; or other present or future developed IEEE 802.11 technologies), IEEE 802.16 protocols (e.g., WMAN, WiMAX, etc.), or the like. While aspects may be described herein using terminology commonly associated with 5G NR, aspects of the present disclosure can be applied to other systems, such as 3G, 4G, and/or systems subsequent to 5G (e.g., 6G).

In the wireless network 100, the UE 102 and any other UE in the system may be, for example, laptop computers, smartphones, tablet computers, machine-type devices such as smart meters or specialized devices for healthcare, intelligent transportation systems, or any other wireless devices with or without a user interface. In network 100, the base station 104 provides the UE 102 network connectivity to a broader network (not shown). This UE 102 connectivity is provided via the air interface 108 in a base station service area provided by the base station 104. In some implementations, such a broader network may be a wide area network operated by a cellular network provider, or may be the Internet. Each base station service area associated with the base station 104 is supported by antennas integrated with the base station 104. The service areas are divided into a number of sectors associated with certain antennas. Such sectors may be physically associated with fixed antennas or may be assigned to a physical area with tunable antennas or antenna settings adjustable in a beamforming process used to direct a signal to a particular sector.

The UE 102 includes control circuitry 110 coupled with transmit circuitry 112 and receive circuitry 114. The transmit circuitry 112 and receive circuitry 114 may each be coupled with one or more antennas. The control circuitry 110 may include various combinations of application-specific circuitry and baseband circuitry. The transmit circuitry 112 and receive circuitry 114 may be adapted to transmit and receive data, respectively, and may include radio frequency (RF) circuitry or front-end module (FEM) circuitry.

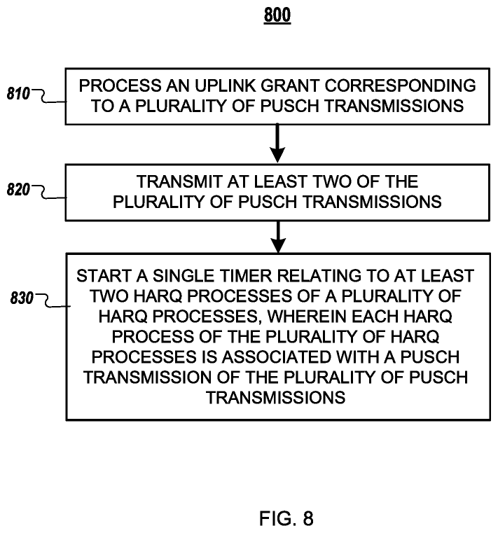

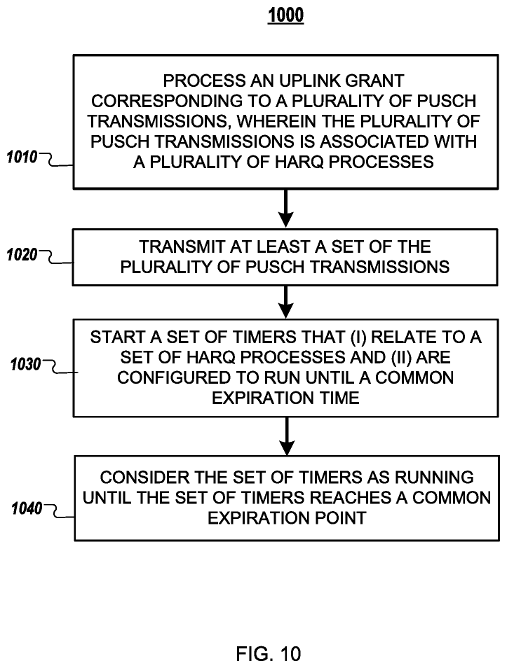

In various implementations, aspects of the transmit circuitry 112, receive circuitry 114, and control circuitry 110 may be integrated in various ways to implement the operations described herein such as the operations of the methods 800 of FIGS. 8 and 1000 of FIG. 10. The control circuitry 110 may be adapted or configured to perform various operations such as those described elsewhere in this disclosure related to a UE. In some implementations, for example, the control circuitry 110 can process an uplink grant, start one or more configured grant timers or one or more configured grant retransmission timers, and/or consider one or more configured grant timers or one or more configured grant retransmission timers.

The transmit circuitry 112 can perform various operations described in this specification such as transmitting one or more PUSCH transmissions of a PUSCH transmission cluster. Additionally, the transmit circuitry 112 may transmit a plurality of multiplexed uplink physical channels. The plurality of uplink physical channels may be multiplexed according to time division multiplexing (TDM) or frequency division multiplexing (FDM) along with carrier aggregation. The transmit circuitry 112 may be configured to receive block data from the control circuitry 110 for transmission across the air interface 108.

The receive circuitry 114 can perform various operations described in this specification receiving an uplink grant. Additionally, the receive circuitry 114 may receive a plurality of multiplexed downlink physical channels from the air interface 108 and relay the physical channels to the control circuitry 110 for processing. For example, the receive circuitry can receive an uplink grant and relay the received uplink grant to the control circuitry 110 for processing. The plurality of downlink physical channels may be multiplexed according to TDM or FDM along with carrier aggregation. The transmit circuitry 112 and the receive circuitry 114 may transmit and receive both control data and content data (e.g., messages, images, video, etc.) structured within data blocks that are carried by the physical channels.

FIG. 1 also illustrates the base station 104. In implementations, the base station 104 may be an NG radio access network (RAN) or a 5G RAN, an E-UTRAN, a non-terrestrial cell, or a legacy RAN, such as a UTRAN or GERAN. As used herein, the term “NG RAN” or the like may refer to the base station 104 that operates in an NR or 5G wireless network 100, and the term “E-UTRAN” or the like may refer to a base station 104 that operates in an LTE or 4G wireless network 100. The UE 102 utilizes connections (or channels) 106A, 106B, each of which includes a physical communications interface or layer.

The base station 104 circuitry may include control circuitry 116 coupled with transmit circuitry 118 and receive circuitry 120. The transmit circuitry 118 and receive circuitry 120 may each be coupled with one or more antennas that may be used to enable communications via the air interface 108. The transmit circuitry 118 and receive circuitry 120 may be adapted to transmit and receive data, respectively, to any UE connected to the base station 104. The transmit circuitry 118 may transmit downlink physical channels includes of a plurality of downlink subframes. The receive circuitry 120 may receive a plurality of uplink physical channels from various UEs, including the UE 102.

In FIG. 1, the one or more channels 106A, 106B are illustrated as an air interface to enable communicative coupling, and can be consistent with cellular communications protocols, such as a GSM protocol, a CDMA network protocol, a UMTS protocol, a 3GPP LTE protocol, an Advanced long term evolution (LTE-A) protocol, a LTE-based access to unlicensed spectrum (LTE-U), a 5G protocol, a NR protocol, an NR-based access to unlicensed spectrum (NR-U) protocol, and/or any of the other communications protocols discussed herein. In implementations, the UE 102 may directly exchange communication data via a ProSe interface. The ProSe interface may alternatively be referred to as a sidelink (SL) interface and may include one or more logical channels, including but not limited to a Physical Sidelink Control Channel (PSCCH), a Physical Sidelink Control Channel (PSCCH), a Physical Sidelink Discovery Channel (PSDCH), and a Physical Sidelink Broadcast Channel (PSBCH).

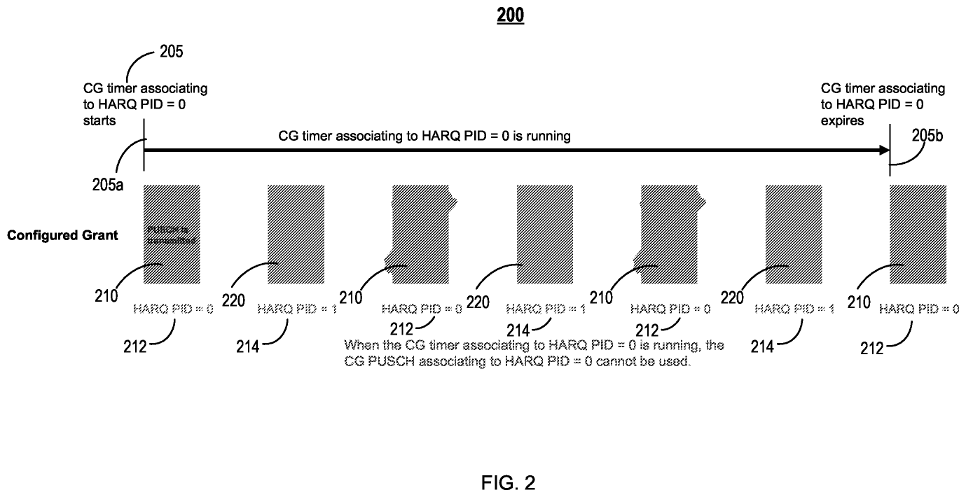

FIG. 2 illustrates a visualization 200 showing features of an uplink grant timer. As shown in FIG. 2, 200, each PUSCH 210, 220 is associated with a hybrid automatic repeat request (HARQ) process ID 212, 214. A CG configuration may comprise multiple PUSCHs with the same HARQ process ID. The uplink grant timer could be any type of timer that may start with PUSCH transmission, such as a configured grant timer or a configured grant retransmission timer.

A configured grant (CG) timer 205 starts when a PUSCH 210 is transmitted (on the first orthogonal frequency division multiplexing (OFDM) symbol of the PUSCH). The configured grant timer 205 corresponds to the HARQ process 212 of the PUSCH 210. In the example of FIG. 2, the PUSCH 210 is a configured grant. However, the process is not so limited. Instead, the PUSCH may be a configured grant or a dynamic grant.

While the CG timer 205 associating to the HARQ process is running (e.g., from 205a to 205b), the UE shall not use CG resources with the same HARQ process. This is to avoid MAC PDU stored in the HARQ buffer being overwritten by new transmission, while the stored MAC PDU is still needed for HARQ retransmission.

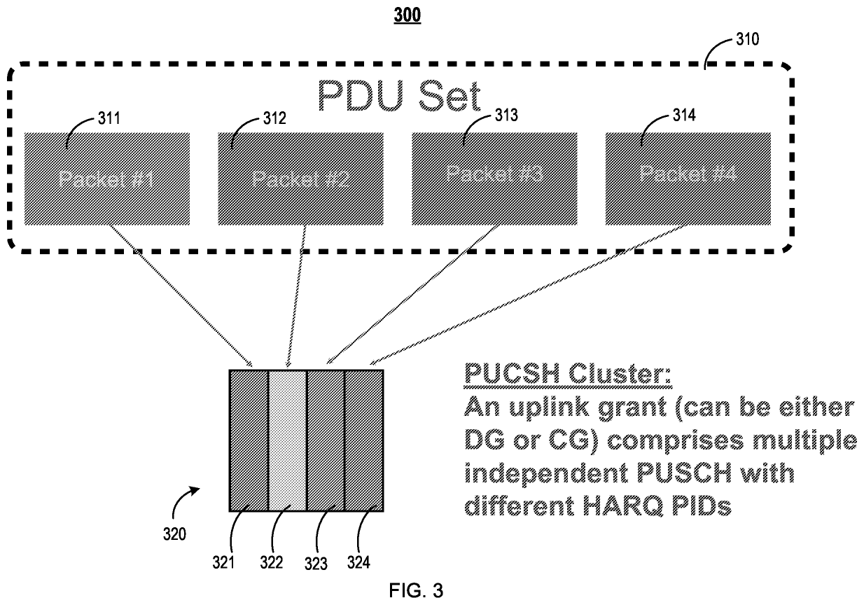

FIG. 3 illustrates a visualization 300 of a PUSCH cluster used for transmission of a PDU set. Certain services such as XR services can operate on a packet data unit (PDU) set 310 which comprises multiple packets 311 to 314 (e.g. IP packets), and each PDU Set 310 can be mapped to different QoS flows. All packets in a PDU set 310 should be delivered within the QoS requirement of a PDU Set Delay Budget (PSDB). When PSDB is exceeded and if any PDU of the PDU set is not yet successfully delivered, the whole PDU set may be discarded as it may not be useful to the application any more.

A PUSCH cluster 320 comprised of a plurality of PUSCH 321, 322, 323, 324 can be used to transmit a PDU set 310. In some implementations, for example, one PUSCH is used to convey one packet within the PDU set, as shown below. In such an example, PUSCH 321, is used to convey packet 311, PUSCH 322 is used to convey packet 312, PUSCH 323 is used to convey packet 313, and PUSCH 324 is used to convey packet 314. However, the present disclosure is not so limited. Instead, in some implementations, for example, multiple PUSCH may be needed convey a single packet. Likewise, in some implementations, a single PUSCH may include data from, for example, two different packets.

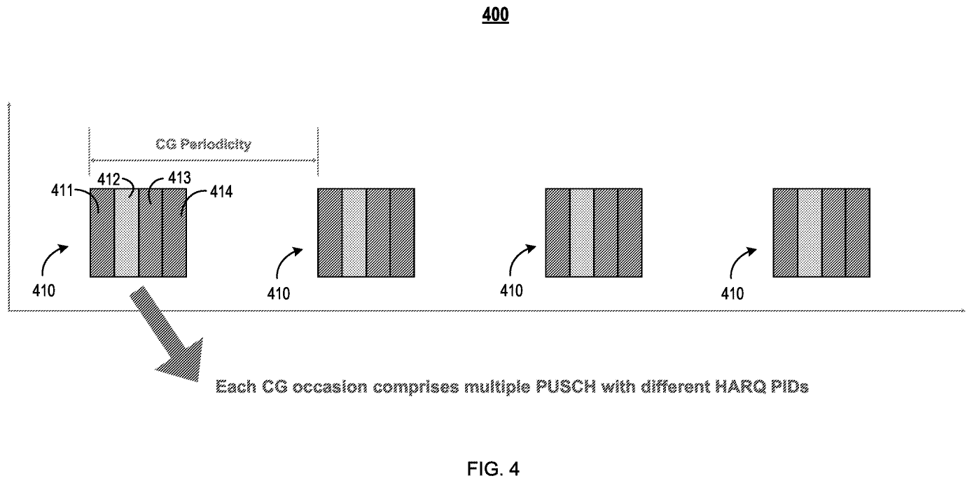

FIG. 4 illustrates a visualization 400 of a PUSCH cluster applied in a uplink grant. As described, an uplink grant may comprise a plurality of PUSCH, which may be referred to herein as a PUSCH cluster or a multi-PUSCH allocation as shown in FIG. 3. In addition, each PUSCH in the cluster can have a different HARQ process ID as shown in FIG. 2.

The example of FIG. 4 shows an example where PUSCH cluster is applied in a configured grant. However, the present disclosure is not so limited. Instead, PUSCH clusters can be applied in any uplink grant including a configured grant or a dynamic grant. However, in some implementations, regardless of whether the uplink grant is a configured grant or a dynamic grant, the uplink grant timer is grant timer is still any type of timer that may start with PUSCH transmission, such as a configured grant timer or a configured grant retransmission timer.

The configured grant with PUSCH cluster 410 can be cyclic or periodic as shown in FIG. 4. Each CG PUSCH cluster 410 occasion shown in FIG. 4 comprises multiple PUSCH 411, 412, 413, 414 with different HARQ PIDs. The configured grant with PUSCH cluster in each cycle can accommodate periodic traffic characteristics such as XR traffic characteristics including jitter and varying packet sizes. Jitter refers to late packet arrival, and since multiple PUSCH can be provisioned in each CG occasion with the PUSCH cluster, the UE does not need to wait until the next CG cycle to transmit this late packet. Varying packet size refers to when the packet size is too large, there will be sufficient resource in each CG occasion can still allow the whole packet to be transmitted on time.

In existing systems, a PUSCH cluster may can have multiple CG Timers—i.e., one for each PUSCH of the PUSCH cluster—that each have a different point of expiration as shown in FIGS. 5A and 5B. In such implementations, the value of a CG timer can be set as the time for potential HARQ retransmission. Once CG timer is expired, the UE can again use the CG resource with the corresponding HARQ process for new transmission.

In the examples of FIGS. 5A and 5B, all packets within a PDU set has a common “delivery deadline” 540A, 540B based on PSDB. However, each PUSCH within the cluster may start at different times, they also expire at different times (e.g., between times 530A, 530B and 550A, 550B). As a result, problems can arise that lends to the inefficient use of uplink grant resource as described below with reference to FIGS. 5A and 5B.

FIG. 5A illustrates a visualization 500A of an example of a problem that arises when using conventional uplink grant timers with a PUSCH cluster. In the example of FIG. 5A, each PUSCH 511A, 512A, 513A, 514A of the PUSCH cluster 510A has a different CG timer 520A, 521A, 522A, 523A. Since each PUSCH starts at a different time, the different CG timers 520A, 521A, 522A, 523A have different expiration points ranging from 530A to 550A. In the example of FIG. 5A, the PDU set delivery deadline 540A based on PSDB is set to 530A. Accordingly, in such an example, some of these CG timers 521A, 522A, 523A are still running after the PDU set delivery deadline 540A. In such instances, during the interval 560A of 530A to 550A, new transmissions on CG resources with some HARQ processes are blocked by the still running CG timers unnecessarily. Solutions of the present disclosure solve this problem by, for example use of a single uplink grant timer or use multiple uplink grant timers having a common expiration point, thus eliminating the interval 560A.

FIG. 5B illustrates a visualization 500B of an example of another problem that arises when using conventional uplink grant timers with a PUSCH cluster. In the example of FIG. 5B, each PUSCH 511B, 512B, 513B, 514B of the PUSCH cluster 510B has a different CG timer 520B, 521B, 522B, 523B. Since each PUSCH starts at a different time, the different CG timers 520B, 521B, 522B, 523B have different expiration points ranging from 530B to 550B. In the example of FIG. 5B, the PDU set delivery deadline 540B based on PSDB is set to 550B. Accordingly, some of these CG timers such as 520B, 521B, 522B are expired before the PDU set delivery deadline 540B. In such instances, during the interval 560B from 530B to 550B some HARQ processes associated with, for example, PUSCH 511B, 512B, 513B may be overwritten by new transmission on some CG resources while they may be still needed for retransmission. Solutions of the present disclosure solve this problem by, for example use of a single uplink grant timer or use multiple uplink grant timers having a common expiration point, thus eliminating the interval 560B.

### Single Uplink Grant Timer for Multiple HARQ Processes

In some implementations, only one uplink grant timer, which in this example, is a configured grant (CG) timer is started in a PUSCH cluster, and this CG timer is associated to multiple HARQ processes corresponding to different PUSCHs within the cluster. When this CG timer is running, all CG resources with any of the HARQ processes associating to this CG timer are not allowed to be used by the UE.

In some implementations, when some of the PUSCH of the cluster are not used by the UE (e.g. due to jitter or smaller payload size): all HARQ processes of the PUSCH cluster are anyway associated to this CG timer. As an alternative for this scenario when some of the PUSCH of the PUSCH cluster are not used by the UE, only the HARQ processes of the PUSCHs actually used by the UE can be associated to this CG timer.

The CG timer value (i.e. how long the timer should be running) can be adaptively changed based on certain conditions, wherein multiple timer values can be pre-configured and the UE selects the time value conditioned on the status of the PUSCH cluster. In some implementations, the timer value may depend on how many PUSCH in the cluster are used. For example, a larger CG timer value if more PUSCHs in the cluster are transmitted. In some implementations, the timer value may depend on how the PUSCH in a cluster are spaced apart. In some implementations, the timer value may depend on when the last PUSCH in a cluster would end.

The starting point and/or value of an uplink grant timer, which in this example is a CG Timer, can be determined in a number of different ways. In some implementations, the starting point of the CG Timer may start in the first OFDM symbol of the first PUSCH of the PUSCH cluster. In some implementations, the starting point of the CG Timer may start after the last OFDM symbol of the first PUSCH of the cluster. In some implementations, the starting point of the CG Timer may start in the first OFDM symbol of the last PUSCH of the cluster. In some implementations, the starting point of the CG Timer may start after the last OFDM symbol of the last PUSCH of the cluster. In some implementations, the starting point of the CG Timer may start in the first OFDM symbol of the last PUSCH in the cluster that is actually used by the UE. In some implementations, the starting point of the CG Timer may start after the last OFDM symbol of the last PUSCH in the cluster that is actually used by the UE. In some implementations, the starting point of the CG Timer may start in the first OFDM symbol of the first PUSCH in the cluster that is actually used by the UE. In some implementations, the starting point of the CG Timer may start after the last OFDM symbol of the first PUSCH in the cluster that is actually used by the UE. In some implementations, the starting point of the CG Timer may be fixed to or (pre)-configured as one of these aforementioned starting point values.

Though an example of an uplink grant timer being a CG Timer is described above, the present disclosure is not so limited. In some implementations, if the PUSCH cluster is associated to a dynamic grant (DG), the starting point and/or value of the CG timer may be indicated in the PDCCH allocating the dynamic PUSCH cluster.

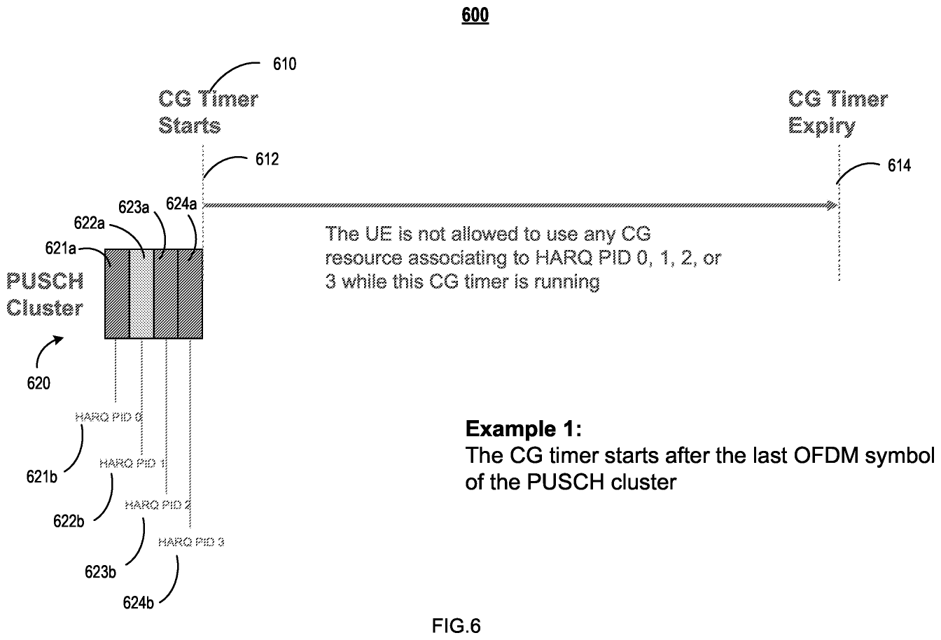

FIG. 6 illustrates a visualization 600 of an example of a single uplink grant timer 610 relating to a plurality of HARQ processes 621b, 622b, 622c, 622d associated with a PUSCH cluster 620, in accordance with one aspect of the present disclosure. In the example of FIG. 6, the single uplink grant timer 610 starts at 612 after the last OFDM symbol of PUSCH 624a of the PUSCH cluster 620 and runs until the uplink grant timer expiration point 614. During the running of this single uplink grant timer 610, the UE is not allowed to use any CG resource associating to HARQ PID 0, 1, 2, or 3. Because only a single uplink grant timer 610 is used, the solution set forth in the example of FIG. 6 eliminates the intervals of 560A, 560B of FIGS. 5A and 5B, thus solving the problems identified with existing methods.

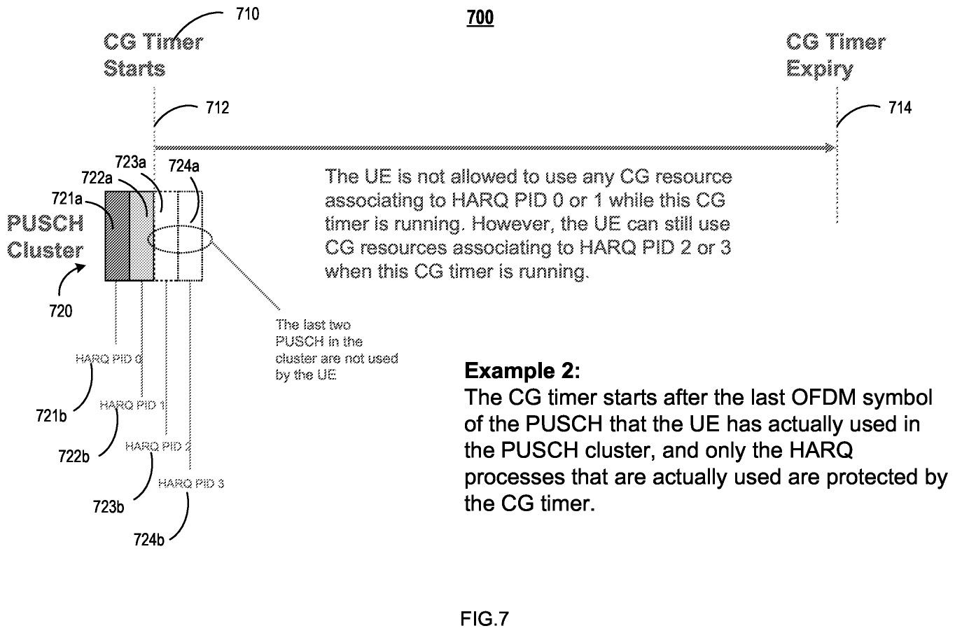

FIG. 7 illustrates another visualization 700 of an example of a single uplink grant timer relating to a plurality of HARQ processes 721b, 722b, 723b, 724b associated with a PUSCH cluster 720, in accordance with one aspect of the present disclosure. In the example of FIG. 7, the single uplink grant timer 710 starts at 712 after the last OFDM symbol of the PUSCH 722a that the UE has actually used in the PUSCH cluster 720 and only the HARQ processes 721b, 722b that are actually used are protected by the uplink grant timer 710, as the uplink grant timer 710 runs until the uplink grant timer expiration point 714. During the running of this single uplink grant timer 710, the UE is not allowed to use any CG resource associating to HARQ PID 0 or 1 721b, 722b. However, the UE can still use CG resources associated to HARQ PID 2 or 3 723b, 724b while the single uplink grant timer 710 timer is running. As a result, this solution solves the problems of FIGS. 5A and 5B by eliminating the interval 560A, 560B, while also freeing up unused CG resources for use by the UE.

FIG. 8 is a flowchart of an example of a process 800 for implementing a single uplink grant timer related to a plurality of HARQ processes associated with a PUSCH transmission cluster, in accordance with one aspect of the present disclosure. For convenience, the process 800 will be described as being performed by UE such as the UE 102 or UE 1100.

A UE can begin execution of the process 800 by processing an uplink grant corresponding to a plurality of PUSCH transmissions (810). In some implementations, the plurality of PUSCH transmissions is associated to a different start time.

The UE can continue execution of the process 800 by transmitting at least two of the plurality of PUSCH transmissions (820).

The UE can continue execution of the process 800 by starting a single timer relating to at least two HARQ processes of a plurality of HARQ processes, wherein each HARQ process of the plurality of HARQ processes is associated with a PUSCH transmission of the plurality of PUSCH transmissions (820). In some implementations, the single timer is a configured grant timer or a configured grant retransmission timer related to the plurality of HARQ processes. However the present disclosure is not so limited.

In some implementations, the UE can continue execution of the process 800 by refraining from performing a new transmission on one or more configured grant resources associated with one or more of the plurality of HARQ processes while the single timer is running.

In some implementations, the single timer is configured to be started at a particular start time. The particular start time of the single timer can be a beginning of a first PUSCH transmission of the plurality of PUSCH transmissions, a beginning of a second PUSCH transmission of the plurality of PUSCH transmissions, a termination of the first PUSCH transmission of the plurality of PUSCH transmissions, or a termination of the second PUSCH transmission of the plurality of PUSCH transmissions. In some implementations, the uplink grant is received via physical downlink control panel (PDCCH) includes an indication of a start time of the single timer.

In some implementations, the UE can be configured with a single timer of a particular duration. For example, in some implementations, the UE is preconfigured with a duration of the single timer. Alternatively, in some implementations, the UE is configured with a duration of the single timer via RRC signaling.

In some implementations, the UE can continue execution of the process 800 by determining a duration of the CG timer based on one or more conditions. In such implementations, the one or more conditions can include (i) a number PUSCH transmissions in the PUSCH transmission cluster, (ii) spacing of PUSCH transmission within the PUSCH transmission cluster, or (iii) when a last PUSCH transmission in the PUSCH transmission cluster ends.

### Common Expiry Timer for Multiple Uplink Grant Timers

In some implementations, each PUSCH of a PUSCH cluster is still associated to one CG timer. Therefore, a separate CG timer starts when a PUSCH within a cluster starts.

However, the network can pre-configure a common expiry point for all CG timers started in a PUSCH cluster, which ensures all CG timers started in a PUSCH will stop at the same time. In some implementations, the common expiry point may be configured in accordance to the PSDB of the PDU Set. (e.g. It could be configured per configured grant configuration). It may be changed dynamically by the L1/L2 signals such as MAC CE. In some implementations, for a dynamically allocated PUSCH cluster (i.e. a PUSCH cluster scheduled by a dynamic grant), the common expiry point could be indicated in the PDCCH allocating the dynamic PUSCH cluster. Alternatively, the common expiry point may be fixed in the specification (e.g., pre-configured into the UE to satisfy a standardization requirement).

The common expiry point may be implemented in a number of different ways. In some implementations, for example, the common expiry point can be implement as a configuration of an absolute timing. In such implementations, an absolute time point is provided by the network (e.g., gNB), and all CG timers started in this PUSCH cluster should stop together when this absolute time is reached. By way of example, the absolute time may be set and fixed to X ms, X OFDM symbols, or X slots after the first or the last PUSCH of the cluster.

In some implementations, for example, the common expiry point can be implemented as a configuration of inter-CG timer references. In such implementations, one of the CG timers started within a PUSCH cluster may be set as a “reference” of at least one other CG timer started within the same PUSCH cluster. Then, the other CG timers should stop if and only if their “reference CG timer” is expired.

In some implementations, the common expiry point can be adaptively determined. In such implementations, for example, the CG timer value for each PUSCH can be adaptively determined based on a formula, which ensures all configured timers started in the same PUSCH cluster would expire at the same time.

In some implementations, an offset can be applied to each PUSCH when determining the CG timer value. More specifically, an offset value (determined based on e.g. the PUSCH index within a cluster) is applied to a default CG timer value for a PUSCH, in order to get a finalized CG timer value that each PUSCH should start in the cluster.

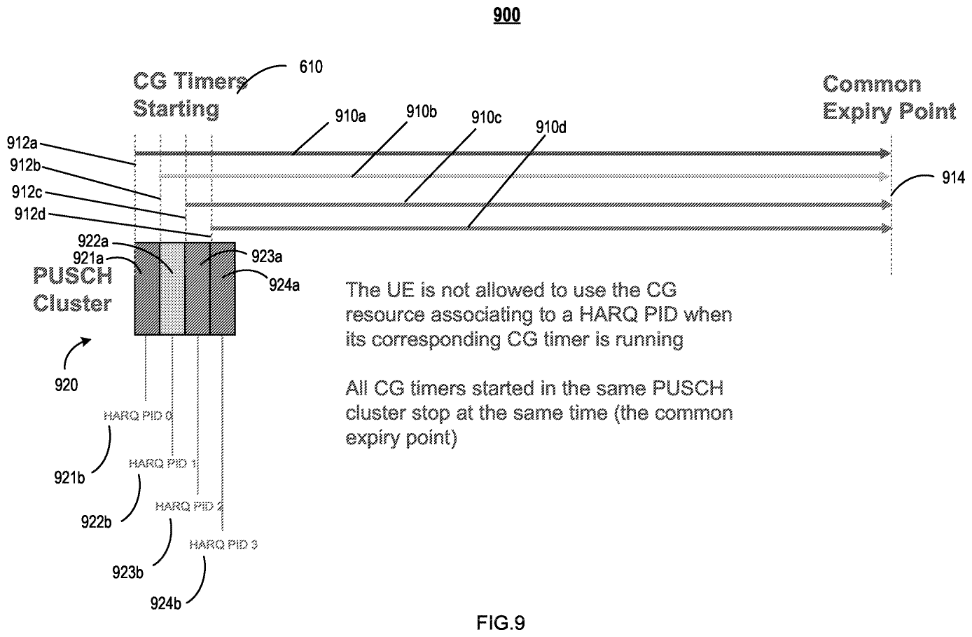

FIG. 9 illustrates a visualization 900 of an example of use of a common expiration time 914 for a plurality of uplink grant timers 910a, 910b, 910c, 910d that each relate to a respective HARQ process 921b, 922b, 923b, 924b associated with a PUSCH cluster 920, in accordance with one aspect of the present disclosure. In the example of FIG. 9, each of the multiple uplink grant timers 910a, 910b, 910c, 910d have different respective starting points 912a, 912b, 912c, 912d. However, each of the multiple uplink grant timers 910a, 910b, 910c, 910d have common expiration point 914. In the example of FIG. 9, the UE is not allowed to use the CG resource associating to a HARQ PID 921b, 922b, 923b, 924b when the corresponding CG timer 910a, 910b, 910c, 910d for the HARQ PID is running. In the example of FIG. 9, all CG timers 910a, 910b, 910c, 910d started in the same PUSCH cluster 920 stop at the same time 914 (i.e., the common expiry point).

FIG. 10 is a flowchart of an example of a process 1000 for implementing a common expiration timer a plurality of uplink grant timers that each relate to a respective HARQ process associated with a PUSCH transmission cluster, in accordance with one aspect of the present disclosure. For convenience, the process 1000 will be described as being performed by UE such as the UE 102 or UE 1100.

A UE can begin execution of the process 1000 by processing an uplink grant corresponding to a plurality of PUSCH transmissions, wherein the plurality of PUSCH transmission is associated with a plurality of HARQ processes (1010). In some implementations, each of the plurality of PUSCH transmissions is associated to a different start time.

The UE can continue execution of the process 1000 by transmitting at least a set of the plurality of PUSCH transmission (1020). In some implementations, the set of the plurality of PUSCH transmission can include two or more PUSCH transmissions.

The UE can continue execution of the process 1000 starting a set of timers that (i) relate to a set of the plurality of HARQ processes and (ii) are configured to run until a common expiration time (1030). In some implementations, the set of the plurality of HARQ processes can include two or more HARQ processes. In some implementations, the set of timers are configured grant timers and each of the configured grant timers are associated with a different HARQ process. In some implementations, the set of timers are configured grant retransmission timers and each of the configured grant retransmission timers are associated with a different HARQ process. In some implementations, each of the set of timers starts at a beginning of each of the plurality of PUSCH transmissions.

The UE can continue execution of the process 1000 by considering the set of timers as running until the set of timers reaches the common expiration point (1040). In some implementations, the UE can continue execution of the process 1000 by stopping the set of timers at the common expiration point.

The common expiration point used by the UE in process 1000 can be obtained, or otherwise determined, by the UE in a number of different ways. For example, in some implementations, the processed uplink grant is received in PDCCH. In some implementations, the value for the common expiration point can also be received in the downlink control information (DCI) via physical downlink control channel (PDCCH). In some implementations, the UE is preconfigured with a common expiration point when the set of timers is to expire. In some implementations, the common expiration point is a predetermined amount of time after a first PUSCH transmission or after a last PUSCH transmission of the PUSCH transmission cluster. In such implementations, the predetermined amount of time is a predetermined number of milliseconds, a predetermined number of OFDM symbols, or a predetermined number of slots. In some implementations, UE's execution of the process 1000 can include dynamically determining the common expiration point that indicates when each of the set of timers is to expire.

In some implementations, the UE's execution of the process 1000 can also include determining the common expiration point when each of the CG timers is to expire based on an offset associated with one or more PUSCH transmissions of the plurality of PUSCH transmissions. In some implementations, this determination stage can include the UE adjusting, for each particular PUSCH transmission of the plurality of PUSCH transmissions, a preconfigured timer for HARQ processes in the particular PUSCH transmission based on the offset associated with the particular PUSCH transmission.

In some implementations, the UE can continue execution of the process 1000 by refraining from performing a new transmission on one or more uplink grant resources associated with one or more of the plurality of HARQ processes when the respective timer for the one or more uplink grant resources is running.

In some implementations, the UE is configured to transmit a set of PDU using the plurality of PUSCH transmissions. In such implementations, the common expiration point can be based on a PDU set delay budget (PSDB) of the set of PDU to be transmitted using the PUSCH transmission cluster.

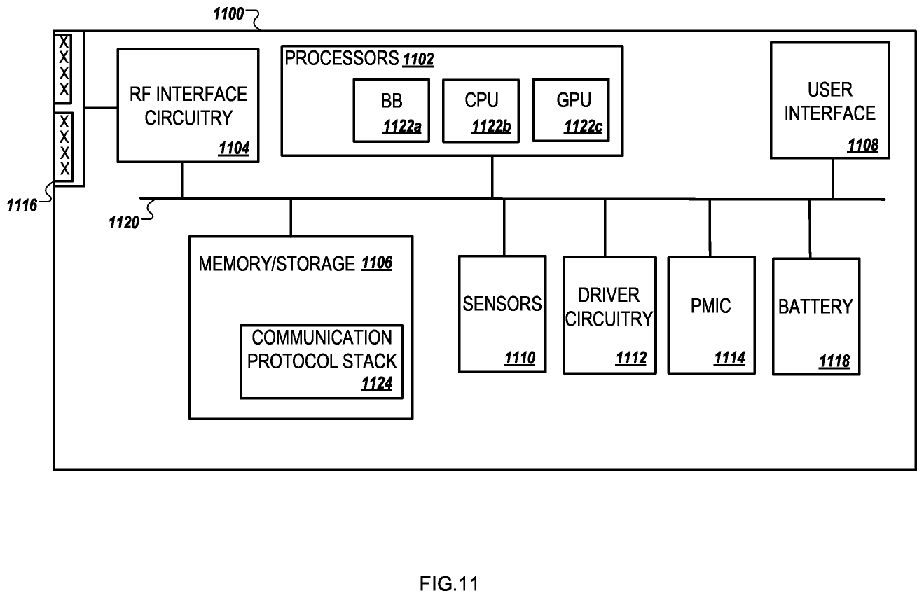

FIG. 11 illustrates a user equipment (UE) 1100, according to some implementations. The UE 1100 may be similar to and substantially interchangeable with UE 102 of FIG. 1.

The UE 1100 may be any mobile or non-mobile computing device, such as, for example, mobile phones, computers, tablets, industrial wireless sensors (for example, microphones, pressure sensors, thermometers, motion sensors, accelerometers, inventory sensors, electric voltage/current meters, etc.), video devices (for example, cameras, video cameras, etc.), wearable devices (for example, a smart watch), relaxed-IoT devices.

The UE 1100 may include processors 1102, RF interface circuitry 1104, memory/storage 1106, user interface 1108, sensors 1110, driver circuitry 1112, power management integrated circuit (PMIC) 1114, antenna structure 1116, and battery 1118. The components of the UE 1100 may be implemented as integrated circuits (ICs), portions thereof, discrete electronic devices, or other modules, logic, hardware, software, firmware, or a combination thereof. The block diagram of FIG. 11 is intended to show a high-level view of some of the components of the UE 1100. However, some of the components shown may be omitted, additional components may be present, and different arrangement of the components shown may occur in other implementations.

The components of the UE 1100 may be coupled with various other components over one or more interconnects 1120, which may represent any type of interface, input/output, bus (local, system, or expansion), transmission line, trace, optical connection, etc. that allows various circuit components (on common or different chips or chipsets) to interact with one another.

The processors 1102 may include processor circuitry such as, for example, baseband processor circuitry (BB) 1122A, central processor unit circuitry (CPU) 1122B, and graphics processor unit circuitry (GPU) 1122C. The processors 1102 may include any type of circuitry or processor circuitry that executes or otherwise operates computer-executable instructions, such as program code, software modules, or functional processes from memory/storage 1106 to cause the UE 1100 to perform operations as described herein such as the operations of the methods of FIG. 8 and FIG. 10.

In some implementations, the baseband processor circuitry 1122A may access a communication protocol stack 1124 in the memory/storage 1106 to communicate over a 3GPP compatible network. In general, the baseband processor circuitry 1122A may access the communication protocol stack to: perform user plane functions at a physical (PHY) layer, medium access control (MAC) layer, radio link control (RLC) layer, packet data convergence protocol (PDCP) layer, service data adaptation protocol (SDAP) layer, and PDU layer; and perform control plane functions at a PHY layer, MAC layer, RLC layer, PDCP layer, RRC layer, and a non-access stratum layer. In some implementations, the PHY layer operations may additionally/alternatively be performed by the components of the RF interface circuitry 1104. The baseband processor circuitry 1122A may generate or process baseband signals or waveforms that carry information in 3GPP-compatible networks. In some implementations, the waveforms for NR may be based cyclic prefix orthogonal frequency division multiplexing (OFDM) “CP-OFDM” in the uplink or downlink, and discrete Fourier transform spread OFDM “DFT-S-OFDM” in the uplink.

The memory/storage 1106 may include one or more non-transitory, computer-readable media that includes instructions (for example, communication protocol stack 1124) that may be executed by one or more of the processors 1102 to cause the UE 1100 to perform various operations described herein. The memory/storage 1106 include any type of volatile or non-volatile memory that may be distributed throughout the UE 1100. In some implementations, some of the memory/storage 1106 may be located on the processors 1102 themselves (for example, L1 and L2 cache), while other memory/storage 1106 is external to the processors 1102 but accessible thereto via a memory interface. The memory/storage 1106 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 1104 may include transceiver circuitry and radio frequency front module (RFEM) that allows the UE 1100 to communicate with other devices over a radio access network. The RF interface circuitry 1104 may include various elements arranged in transmit or receive paths. These elements may include, for example, switches, mixers, amplifiers, filters, synthesizer circuitry, control circuitry, etc.

In the receive path, the RFEM may receive a radiated signal from an air interface via antenna structure 1116 and proceed to filter and amplify (with a low-noise amplifier) the signal. The signal may be provided to a receiver of the transceiver that downconverts the RF signal into a baseband signal that is provided to the baseband processor of the processors 1102.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 1116. In various implementations, the RF interface circuitry 1104 may be configured to transmit/receive signals in a manner compatible with NR access technologies.

The antenna 1116 may include antenna elements to convert electrical signals into radio waves to travel through the air and to convert received radio waves into electrical signals. The antenna elements may be arranged into one or more antenna panels. The antenna 1116 may have antenna panels that are omnidirectional, directional, or a combination thereof to enable beamforming and multiple input, multiple output communications. The antenna 1116 may include microstrip antennas, printed antennas fabricated on the surface of one or more printed circuit boards, patch antennas, phased array antennas, etc. The antenna 1116 may have one or more panels designed for specific frequency bands including bands in FR1 or FR2.

The user interface 1108 includes various input/output (I/O) devices designed to enable user interaction with the UE 1100. The user interface 1108 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes “LEDs” and multi-character visual outputs), or more complex outputs such as display devices or touchscreens (for example, liquid crystal displays “LCDs,” LED displays, quantum dot displays, projectors, etc.), with the output of characters, graphics, multimedia objects, and the like being generated or produced from the operation of the UE 1100.

The sensors 1110 may include devices, modules, or subsystems whose purpose is to detect events or changes in its environment and send the information (sensor data) about the detected events to some other device, module, subsystem, etc. Examples of such sensors include, inter alia, inertia measurement units including accelerometers, gyroscopes, or magnetometers; microelectromechanical systems or nanoelectromechanical systems including 3-axis accelerometers, 3-axis gyroscopes, or magnetometers; level sensors; temperature sensors (for example, thermistors); pressure sensors; image capture devices (for example, cameras or lensless apertures); light detection and ranging sensors; proximity sensors (for example, infrared radiation detector and the like); depth sensors; ambient light sensors; ultrasonic transceivers; microphones or other like audio capture devices; etc.

The driver circuitry 1112 may include software and hardware elements that operate to control particular devices that are embedded in the UE 1100, attached to the UE 1100, or otherwise communicatively coupled with the UE 1100. The driver circuitry 1112 may include individual drivers allowing other components to interact with or control various input/output (I/O) devices that may be present within, or connected to, the UE 1100. For example, driver circuitry 1112 may include a display driver to control and allow access to a display device, a touchscreen driver to control and allow access to a touchscreen interface, sensor drivers to obtain sensor readings of sensor circuitry 1110 and control and allow access to sensor circuitry 1110, drivers to obtain actuator positions of electro-mechanic components or control and allow access to the electro-mechanic components, a camera driver to control and allow access to an embedded image capture device, audio drivers to control and allow access to one or more audio devices.

The PMIC 1114 may manage power provided to various components of the UE 1100. In particular, with respect to the processors 1102, the PMIC 1114 may control power-source selection, voltage scaling, battery charging, or DC-to-DC conversion.

In some implementations, the PMIC 1114 may control, or otherwise be part of, various power saving mechanisms of the UE 1100. A battery 1118 may power the UE 1100, although in some examples the UE 1100 may be mounted deployed in a fixed location, and may have a power supply coupled to an electrical grid. The battery 1118 may be a lithium ion battery, a metal-air battery, such as a zinc-air battery, an aluminum-air battery, a lithium-air battery, and the like. In some implementations, such as in vehicle-based applications, the battery 1118 may be a typical lead-acid automotive battery.

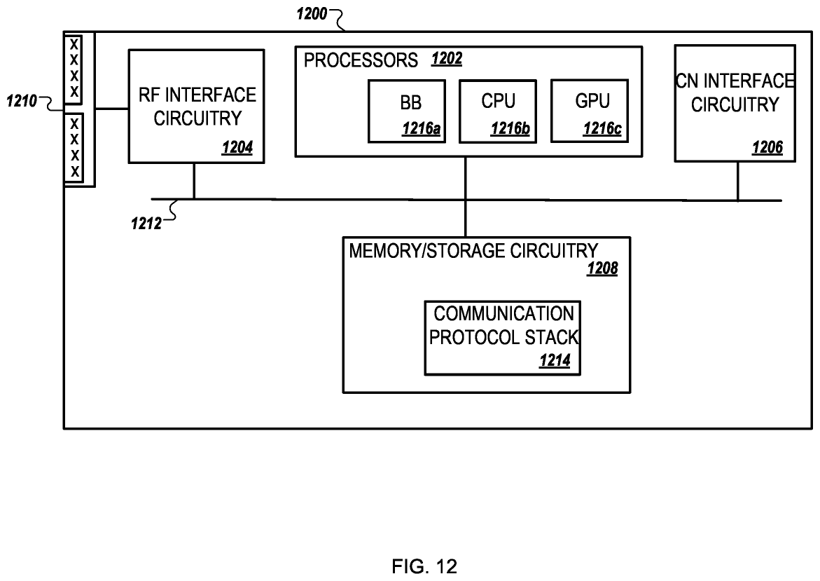

FIG. 12 illustrates an access node 1200 (e.g., a base station or gNB), according to some implementations. The access node 1200 may be similar to and substantially interchangeable with base station 104. The access node 1200 may include processors 1202, RF interface circuitry 1204, core network (CN) interface circuitry 1206, memory/storage circuitry 1208, and antenna structure 1210.

The components of the access node 1200 may be coupled with various other components over one or more interconnects 1212. The processors 1202, RF interface circuitry 1204, memory/storage circuitry 1208 (including communication protocol stack 1214), antenna structure 1210, and interconnects 1212 may be similar to like-named elements shown and described with respect to FIG. 11. For example, the processors 1202 may include processor circuitry such as, for example, baseband processor circuitry (BB) 1216A, central processor unit circuitry (CPU) 1216B, and graphics processor unit circuitry (GPU) 1216C.

The CN interface circuitry 1206 may provide connectivity to a core network, for example, a 5th Generation Core network (5GC) using a 5GC-compatible network interface protocol such as carrier Ethernet protocols, or some other suitable protocol. Network connectivity may be provided to/from the access node 1200 via a fiber optic or wireless backhaul. The CN interface circuitry 1206 may include one or more dedicated processors or FPGAs to communicate using one or more of the aforementioned protocols. In some implementations, the CN interface circuitry 1206 may include multiple controllers to provide connectivity to other networks using the same or different protocols.

As used herein, the terms “access node,” “access point,” or the like may describe equipment that provides the radio baseband functions for data and/or voice connectivity between a network and one or more users. These access nodes can be referred to as BS, gNBs, RAN nodes, eNBs, NodeBs, RSUs, TRxPs or TRPs, and so forth, and can include ground stations (e.g., terrestrial access points) or satellite stations providing coverage within a geographic area (e.g., a cell). As used herein, the term “NG RAN node” or the like may refer to an access node 1200 that operates in an NR or 5G system (for example, a gNB), and the term “E-UTRAN node” or the like may refer to an access node 1200 that operates in an LTE or 4G system (e.g., an eNB). According to various implementations, the access node 1200 may be implemented as one or more of a dedicated physical device such as a macrocell base station, and/or a low power (LP) base station for providing femtocells, picocells or other like cells having smaller coverage areas, smaller user capacity, or higher bandwidth compared to macrocells.

In some implementations, all or parts of the access node 1200 may be implemented as one or more software entities running on server computers as part of a virtual network, which may be referred to as a CRAN and/or a virtual baseband unit pool (vBBUP). In V2X scenarios, the access node 1200 may be or act as a “Road Side Unit.” The term “Road Side Unit” or “RSU” may refer to any transportation infrastructure entity used for V2X communications. An RSU may be implemented in or by a suitable RAN node or a stationary (or relatively stationary) UE, where an RSU implemented in or by a UE may be referred to as a “UE-type RSU,” an RSU implemented in or by an eNB may be referred to as an “eNB-type RSU,” an RSU implemented in or by a gNB may be referred to as a “gNB-type RSU,” and the like.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112(f) interpretation for that component.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

A system, e.g., a base station, an apparatus including one or more baseband processors, and so forth, can be configured to perform particular operations or actions by virtue of having software, firmware, hardware, or a combination of them installed on the system that in operation causes or cause the system to perform the actions.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

1-13. (canceled)

14. One or more processors configured to, when executing instructions stored in a memory, perform operations comprising:
receiving a single uplink grant that schedules a plurality of physical uplink shared channel (PUSCH) transmissions;
instructing radio frequency (RF) circuitry to transmit the plurality of PUSCH transmissions in accordance with the single uplink grant; and
starting a single timer for a plurality of hybrid automatic repeat request (HARQ) processes, wherein each HARQ process of the plurality of HARQ processes is associated with a PUSCH transmission of the plurality of PUSCH transmissions.

15. The one or more processors of claim 14, wherein the single timer is a configured grant timer or a configured grant retransmission timer associated with the plurality of HARQ processes.

16. The one or more processors of claim 14, wherein the single uplink grant is a configured grant or a dynamic grant.

17. The one or more processors of claim 14, wherein each of the plurality of PUSCH transmissions has a different start time.

18. The one or more processors of claim 14, wherein the single timer starts at a time corresponding to:
a beginning of a first PUSCH transmission of the plurality of PUSCH transmissions,
a beginning of a second PUSCH transmission of the plurality of PUSCH transmissions,
a termination of the first PUSCH transmission of the plurality of PUSCH transmissions, or
a termination of the second PUSCH transmission of the plurality of PUSCH transmissions.

19. The one or more processors of claim 14, the operations further comprising:
refraining from performing a new transmission using one or more configured grant resources associated with one or more HARQ processes of the plurality of HARQ processes while the single timer is running.

20. The one or more processors of claim 14, wherein a duration of the single timer is preconfigured.

21. The one or more processors of claim 14, wherein a duration of the single timer is configured via radio resource control (RRC) signaling.

22. The one or more processors of claim 14, the operations further comprising:
determining a duration of the single timer based at least on one or more conditions.

23. The one or more processors of claim 22, the one or more conditions including (i) a number of PUSCH transmissions scheduled by the single uplink grant, (ii) a spacing of PUSCH transmissions scheduled by the single uplink grant, or (iii) an end time of a last PUSCH transmission scheduled by the single uplink grant.

24. The one or more processors of claim 14, wherein the single uplink grant is received via a physical downlink control channel (PDCCH), the single uplink grant indicating a start time of the single timer.

25. A method comprising:
receiving a single uplink grant that schedules a plurality of physical uplink shared channel (PUSCH) transmissions;
transmitting the plurality of PUSCH transmissions in accordance with the single uplink grant; and
starting a single timer for a plurality of hybrid automatic repeat request (HARQ) processes, wherein each HARQ process of the plurality of HARQ processes is associated with a PUSCH transmission of the plurality of PUSCH transmissions.

26. The method of claim 25, wherein the single timer is a configured grant timer or a configured grant retransmission timer associated with the plurality of HARQ processes.

27. The method of claim 25, wherein the single uplink grant is a configured grant or a dynamic grant.

28. The method of claim 25, wherein each of the plurality of PUSCH transmissions has a different start time.

29. The method of claim 25, wherein the single timer starts at a time corresponding to:
a beginning of a first PUSCH transmission of the plurality of PUSCH transmissions,
a beginning of a second PUSCH transmission of the plurality of PUSCH transmissions,
a termination of the first PUSCH transmission of the plurality of PUSCH transmissions, or
a termination of the second PUSCH transmission of the plurality of PUSCH transmissions.

30. The method of claim 25, further comprising:
refraining from performing a new transmission using one or more configured grant resources associated with one or more HARQ processes of the plurality of HARQ processes while the single timer is running.

31. The method of claim 25, wherein a duration of the single timer is preconfigured.

32. The method of claim 25, wherein a duration of the single timer is configured via radio resource control (RRC) signaling.

33. An apparatus comprising:
a memory;
a transceiver; and
a processor coupled to the memory and configured to, when executing instructions stored in the memory, cause the apparatus to perform operations comprising:
receiving a single uplink grant that schedules a plurality of physical uplink shared channel (PUSCH) transmissions;
transmitting the plurality of PUSCH transmissions in accordance with the single uplink grant; and
starting a single timer for a plurality of hybrid automatic repeat request (HARQ) processes, wherein each HARQ process of the plurality of HARQ processes is associated with a PUSCH transmission of the plurality of PUSCH transmissions.
